(19) United States
(12) Patent Application Publication
(10) Pub. No.: US 2012/0173312 A1
(43) Pub. Date: Jul. 5, 2012

(54) SYSTEMS, METHODS, AND MEDIA FOR PROVIDING VIRTUAL BADGES

(76) Inventor: Mark Kern, Aliso Viejo, CA (US)

(21) Appl. No.: 13/342,185

(22) Filed: Jan. 2, 2012

Related U.S. Application Data
(60) Provisional application No. 61/429,342, filed on Jan. 3, 2011.

(51) Int. Cl. G06Q 30/02

(52) U.S. Cl. 705/14.1

(57) ABSTRACT

Systems, methods, and media for facilitating virtual badges within e-commerce systems associated with enterprises are provided herein. Methods may include providing a virtual badge that is displayable via a graphical user interface, the virtual badge being provided in response to at least one action executed by the consumer within an e-commerce system, the virtual badge comprising a visual representation that is based upon user profile data associated with the consumer.

### CROSS-REFERENCE TO RELATED APPLICATIONS

This non-provisional patent application is related to U.S. Provisional Application Ser. No. 61/429,342, filed on Jan. 3, 2011, entitled “E-COMMERCE BADGE SYSTEM”—which is hereby incorporated by reference herein in its entirety.

### FIELD OF THE TECHNOLOGY

Embodiments of the disclosure relate to systems and methods that facilitate the use of virtual badges within e-commerce systems. Systems and methods provided herein may generate and provide virtual badges to consumers. These virtual badges may be collected and redeemed for rewards.

### BACKGROUND OF THE DISCLOSURE

Competition and lack of consumer loyalty within e-commerce systems present unique challenges for e-commerce enterprises. While consumers are increasingly utilizing e-commerce websites to purchase products and services, these websites are ubiquitous throughout the Internet and e-commerce systems are often in search of processes which build and reinforce consumer loyalty.

### SUMMARY OF THE DISCLOSURE

According to some embodiments, the present technology may be directed to methods for facilitating virtual badges within e-commerce systems associated with enterprises. The methods may include at least the step of providing a virtual badge that is displayable via a graphical user interface, the virtual badge being provided in response to at least one action executed by the consumer within an e-commerce system, the virtual badge comprising a visual representation that is based upon user profile data associated with the consumer.

According to other embodiments, the present technology may be directed to systems for facilitating virtual badges within e-commerce systems associated with enterprises. These systems may include: (a) a memory for storing an executable instructions that facilitate virtual badges within e-commerce systems associated with enterprises; (b) a processor that executes the instructions; (c) a notification module that receives a request to generate a virtual badge, the virtual badge being generated in response to at least one action executed by the consumer within an e-commerce system; (d) a virtual badge generator that generates the virtual badge, the virtual badge comprising a visual representation that is based upon user profile data associated with the consumer; and (e) a user interface module that provides a virtual badge that is displayable via a graphical user interface.

According to additional embodiments, the present technology may be directed to computer readable storage media for facilitating virtual badges within e-commerce systems associated with enterprises. The storage media may include a program embodied thereon, the program being executable by a processor to perform a method for facilitating virtual badges within e-commerce systems associated with enterprises. The methods may include at least the step of providing a virtual badge that is displayable via a graphical user interface, the virtual badge being provided in response to at least one action executed by the consumer within an e-commerce system, the virtual badge comprising a visual representation that is based upon user profile data associated with the consumer.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 illustrates an exemplary system for practicing aspects of the present technology;

FIG. 2 shows an exemplary virtual badge application;

FIG. 3 is a flowchart of an exemplary method for facilitating virtual badges within e-commerce systems associated with enterprises; and

FIG. 4 illustrates an exemplary computing system that may be used to implement embodiments according to the present technology.

### DETAILED DESCRIPTION

In the following description, for purposes of explanation, numerous specific details are set forth in order to provide a thorough understanding of the disclosure. It will be apparent, however, to one skilled in the art, that the disclosure may be practiced without these specific details. In other instances, structures and devices are shown at block diagram form only in order to avoid obscuring the disclosure.

Generally speaking, the present technology is directed to systems, methods, and media for facilitating virtual badges within e-commerce systems associated with enterprises. More specifically, the present technology facilitates the use of virtual badges within e-commerce environments. The present technology may build customer loyalty and brand recognition for an enterprise.

Virtual badges may be provided as an enticement to elicit many different forms of customer behavior, particularly behaviors that generate revenue for the enterprise, either directly or indirectly. An exemplary direct consumer behavior may include actions such as purchasing a product or service, while indirect behaviors may include, but are not limited to, completing a form, visiting a web page, watching media, and so forth.

In general, a virtual badge may include a visual representation that may be displayed within a web page, a user interface associated with, for example, a web-based application, a web-based user interface, a widget, and so forth. The visual representation may depict an aspect of the action that was completed by the consumer. For example, if the action includes the purchase of a product, the visual representation may include an image of the product. In other instances, the visual representation may be specifically tailored to consumer. That is, demographic, psychographic, or other preference information associated with the consumer may be utilized. For example, a user profile may indicate that a consumer's favorite color is blue. The visual representation that is generated may be colored blue. While being a rather simplistic example, one of ordinary skill in the art will readily appreciate that many other combinations of consumer specific information may be utilized in the generation of visual representations for a virtual badge.

The present technology may also implement schemas that govern the ways, in which the virtual badges are rewarded. Advantageously, these schemas may maximize or optimize consumer participation. For example, a schema may selectively vary how virtual badges are awarded in response to consumer actions.

Additionally, the schemas may specify groups or collections of virtual badges that may be collected by consumers. A reward may be provided to a customer in response to the customer receiving one or more virtual badges (whether or not they are required for a collection). Rewards may include, for example, a one time sale codes, permanent discounts, free shipping, and so forth.

These and other advantages of the present technology will be described in greater detail with reference to the collective figures.

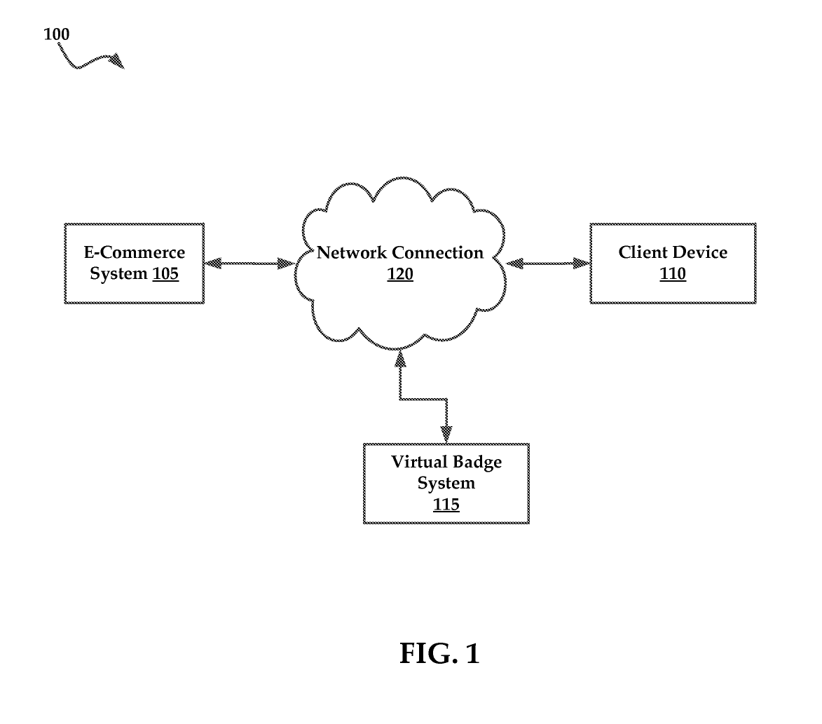

FIG. 1 illustrates an exemplary system 100 for practicing aspects of the present technology. The system 100 may include an e-commerce system 105 that provides one or more e-commerce websites to a plurality of client devices, such as client device 110. According to some embodiments, the system 100 may also comprise a virtual badge system, hereinafter system 115 that is communicatively coupled with the e-commerce system 105 via a network connection 120. The network connection 120 may include any one (or combination) of a number of private or public communications media such as the Internet. In some instances, the e-commerce system 105 may communicatively couple with the system 115 via, for example, an application programming interface (API). Client device 110 may also communicatively couple with the e-commerce system 105 and the system 115 via the network connection 120.

The system 115 may be generally described as a particular purpose computing system that facilitates virtual badges within e-commerce systems associated with enterprises. The system 115 may provide a virtual badge that is displayable via a graphical user interface. In some instances, the virtual badge may be provided in response to at least one action executed by the consumer within an e-commerce system. Furthermore, the virtual badge may comprise a visual representation that is based upon user profile data associated with the consumer.

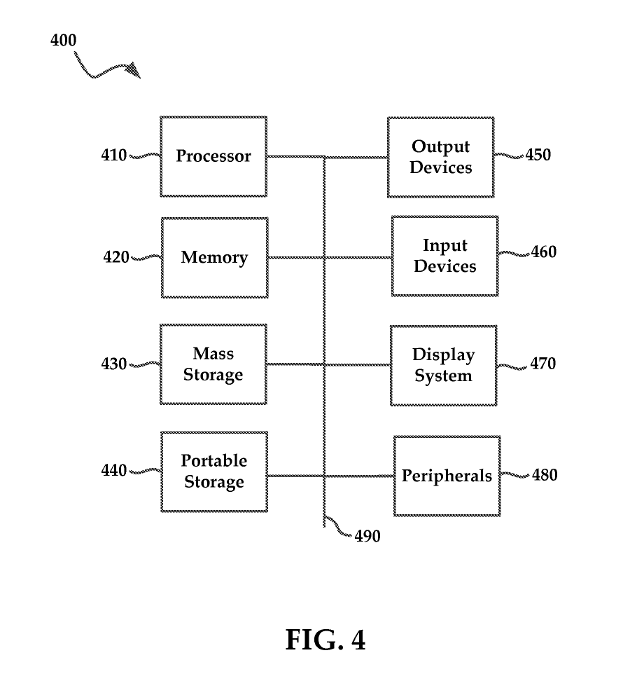

Generally, the system 115 may include executable instructions that are stored in the memory of the system 115 and are executable by the processor of the system 115 to facilitate virtual badges of the present technology. Components of the system 115 may be generally described with reference to computing system 400, which is described in greater detail infra, with reference to FIG. 4.

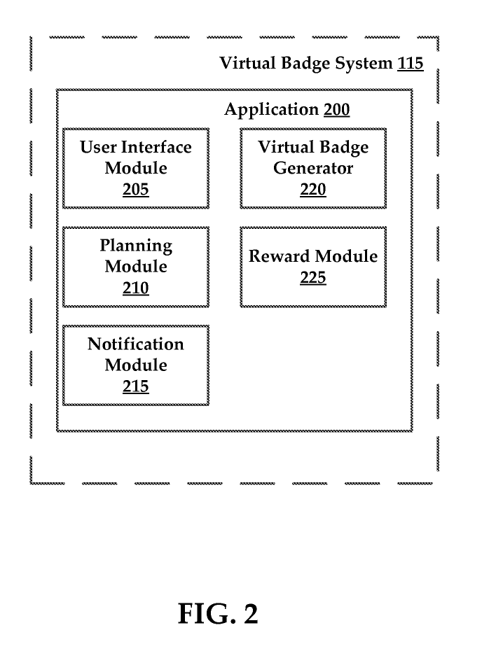

Referring now to FIG. 2, according to some embodiments, the system 115 may include executable instructions that are embodied in a virtual badge application, hereinafter application 200. The application 200 may comprise a user interface module 205, a planning module 210, a notification module 215, a virtual badge generator 220, and a reward module 225.

While the application 200 has been described as being stored in memory within the system 115, it will be understood that in some instances, the application 200 may include an executable application, extension, plug-in, or other mechanism that may be stored locally within the e-commerce system 105.

It is noteworthy that the application 200 may include additional or fewer modules, engines, or components, and still fall within the scope of the present technology. As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality. In other embodiments, individual modules of the application 200 may include separately configured web servers.

In instances where the application 200 resides remotely from the e-commerce system 105, the user interface module 205 may be executed to allow an administrator associated with the e-commerce system 105 to access the application 200. The user interface module 205 may generate one or more user interfaces that allow the administrator to input information that defines a virtual badge implementation plan for their e-commerce system 105. This implementation plan may be referred to as a schema. Generally speaking, the schema may include descriptions of one or more actions that when executed by a consumer, result in the provision of a virtual badge. For example, the schema may designate that upon the purchase of a product, the consumer is to receive a particular type of virtual badge. In some instances, it may be specified that multiple actions may need to be executed before a virtual badge is provided.

It is noteworthy that some actions may specified may include actions that are directly or indirectly associated with revenue generation for the enterprise. Again, an exemplary direct consumer behavior may include actions such as purchasing a product or service, while indirect behaviors may include, but are not limited to, completing a form, visiting a web page, watching media, and so forth.

The schemas may also define collections of virtual badges. Each collection may include requirements for obtaining certain numbers of virtual badges before the provision of a virtual badge. For example, a collection may require that a consumer fill out a profile form or respond to a survey to receive a first badge. The consumer may then be required to purchase a product to receive a second badge. Thirdly, the consumer may then be required to share a review of the product to receive a third badge. Next, the consumer may be required to post the review to one or more social networks to receive a fourth badge.

The collection may specify that a virtual badge is to be provided only upon the consumer obtaining all four badges, or in other implementations, only a portion of the four badges.

The schema information provided by the administrator may be coalesced by the planning module 210 to generate the schema for the e-commerce system, which is then implemented by additional components of the application 200, as will be described below. In addition to the schema generated by the administrator, the planning module 210 may selectively modify the schema over time, or in response to the behavior of the customers. For example, the planning module 210 may selectively modify the number of actions that must be executed by the consumer to obtain a virtual badge.

That is, the application 200 advantageously enhances and elicits consumer participation relative to the e-commerce system 105. In other words, the provision of virtual badges is tied to increasing revenue generating or brand building actions by consumers within the e-commerce system 105. While the virtual badge system 115 remains an entertaining and engaging behavior, commercial benefits for the e-commerce enterprise increase.

Therefore, to elicit consumer participation with the virtual badge system, the planning module 210 may selectively modify the schema over time to encourage consumer participation. For example, when consumers initially engage with the virtual badge technology, it may be advantageous to leverage sensations of immediate gratification to entice consumers to use the virtual badge technology. Therefore, obtaining virtual badges may initially require little effort.

On the other hand, as consumers appear to engage more frequently (e.g., obtaining more virtual badges), the planning module 210 may selectively modify the requirements for obtaining badges. For example, the planning module 210 may increase the number of actions that must be completed before a virtual badge is rewarded.

As would be understood by one of ordinary skill in the art, the planning module 210 may fine tune the schema over time via feedback received from the e-commerce system 105. For example, the administrator may desire to see a consumer execute a predetermined number of actions within a given period of time. The planning module 210 may adjust the requirements for providing a virtual badge based upon such criteria.

In some instances, the planning module 210 may define the use of rare or difficult to obtain virtual badges. Rare badges may be provided on a random basis, or according to other criteria that may or may not depend upon consumer actions.

The following few paragraphs describe basic categories of virtual badges that may be obtained by consumers. Initial virtual badges commemorate the first time a customer performs an action. For example, an initial action may include signing up a profile for the badges system. Other initial actions can include the first purchase within one or more categories such as clothing, or a first post on social network about the enterprise, and the like.

Another type of virtual badge may relate consumer actions relative to merchandise. These actions may overlap with initial actions such as “first coat purchased” but they can also be things like “Bought ten coats” or “Bought something Red.” Other actions may include searching for certain types of merchandise.

Other actions may be driven by purchases or timing/event based actions. For example, a “night owl” virtual badge may be generated by a consumer making a purchase in the middle of the night. Virtual badges may also include location based information that indicates the location of the consumer during a purchase. Different virtual badges may be created for each purchase made by a consumer at a physical outlet associated with the enterprise.

These and many other types of virtual badge/consumer action combinations may likewise be utilized in accordance with the present technology.

Notification of the completion of an action may be provided to the application 200 via the notification module 215. The notification may be received from the e-commerce system 105, a third party such as a payment processor, or may be determined by notification module itself.

Once a notification has been received, the notification module 215 may evaluate the notification to determine the type of action that prompted the generation and communication of the notification, or any other information that may be necessary to generate a virtual badge. The notification module 215 may also obtain information regarding the request from the e-commerce system 105.

Using the information gathered from the notification, the virtual badge generator 220 may be executed to generate a virtual badge. Generally speaking, a virtual badge may include a visual representation that represents the completion of an action. The visual representation may include any visual depiction such as a shape, an image, text, or other content that would be known to one of ordinary skill in the art. Specific details for the visual representation may draw from the action itself. For example, if the action includes purchasing a product, the visual depiction may include an image of the product that was purchased.

Additionally, a virtual badge may be tailored to the consumer via any type of collectable information that has been obtained about the consumer. Non-limiting examples of consumer information include consumer preferences, demographic, psychographic, web analytics for the consumer, and so forth. For example, if user preferences indicate that the consumer's favorite color is blue, the virtual badge may incorporate the color blue.

In addition to generating virtual badges, the virtual badge generator 220 may provide indications of the completion of a collection of virtual badges. For example, when a collection of virtual badges is complete, the virtual badge generator 220 may generate an indicator such as a star, a “thumbs-up,” and so forth.

Additionally, the virtual badge generator 220 may also generate an announcement, such as an animation, that a virtual badge has been obtained by the consumer. Any type of announcement may be generated, but a non-limiting example would include virtual fireworks, the playing of an audio file and/or a video clip, along with many other announcements that would be created by one of ordinary skill in the art. The inclusion of indicators or animations may further entice consumers to obtain badges to discover additional indicators or animations.

Once virtual badges, indicators, and/or notifications, hereinafter described as “content” have been generated, the user interface module 205 may provide the content for display via the website(s) hosted or managed by the e-commerce system 105. That is, in instances where the e-commerce system 105 interfaces with the application 200 via an API, the content may be communicated to the e-commerce system 105, where it is incorporated into the website(s) hosted thereon. Alternatively, the content may be exported in the form of a widget or other embeddable mechanism that may allow the content to be displayed on the website(s) of the e-commerce system 105, whether or not the content is stored or hosted by the e-commerce system 105.

According to some embodiments, the user interface module 205 may generate web pages, such as a consumer profile page, that includes the “content” described above, which may be provided to, or accessible by third party end users. For example, other consumers may be provided notifications that inform them when other consumers earn virtual badges, such as with virtual trophy room or hall of frame. In other examples, notification of a consumer achieving a virtual badge and/or reward may be propagated through a social network. In additional embodiments, views or notifications associated with the content may be accessible via a real simple syndication (RSS) feed to which a plurality of consumers belong. Communication of content to other consumers may foster and develop competition within the social network or group. Such competition may lead to increased participation within the system.

In other instances, the user interface module 205 may provide representations of virtual badges that are interactive and informational. For example, clicking or hovering a mouse cursor over a representation of the virtual badge may not only result in the display of informational content that describes the context under which the virtual badge was obtained, but may also include a list of consumers within the social network that have obtained that particular virtual badge. Other types of information that would be known to one of ordinary skill in the art may also likewise be generated and displayed by the user interface module 205.

Finally, in addition to the provision of content, the reward module 225 may be executed to provide a virtual or physical reward to a consumer. For example, rewards may include a one time sale codes, permanent discounts, free shipping, and so forth. Rewards may be provided based upon the consumer receiving a virtual badge, completing at least a portion of a collection of virtual badges, completing an entire collection of virtual badges, achieving a predetermined number of virtual badges within a given period of time, or other metrics associated with the consumer obtaining virtual badges. It will be understood that the reward may further generate revenue or recognition for the enterprise by enticing the consumer into utilizing the reward. As can be appreciated, virtual rewards may be provided to the consumer via the graphical user interface, via electronic mail messaging, short message service messages, and the like.

In instances where physical rewards are provided, it will be understood that the reward module 225 may generate the necessary communications that result in the consummation of the creation and delivery of the physical reward. For example, the reward module 225 may include mechanisms for generating a message such as an email that is directed to a party responsible for the fulfillment of the reward.

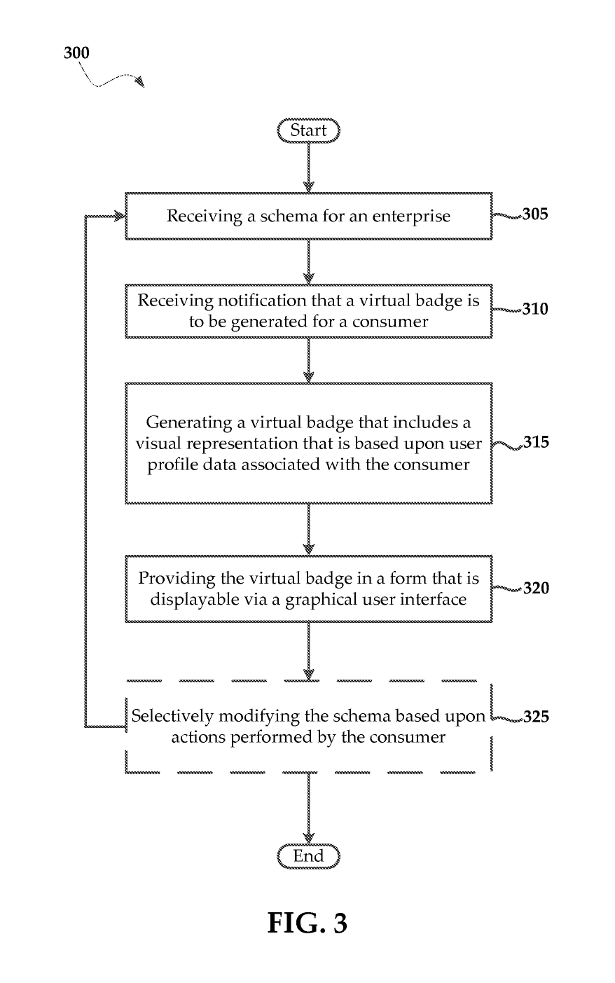

FIG. 3 illustrates a flowchart of an exemplary method 300 for facilitating virtual badges within e-commerce systems associated with enterprises. The method 300 may include a step 305 of receiving a schema for an enterprise. The schema defines the actions that may result in the provision of a virtual badge or other content to a consumer.

The method 300 may also include a step 310 of receiving notification that a virtual badge is to be generated for a consumer. In some instances, the notification is generated by actions executed by a consumer, such as purchasing a product, searching for merchandise on an e-commerce website, visiting one or more pages of the e-commerce website, and the like. Notifications may be received from a third party such as a payment processor.

Upon receiving notification, the method 300 may include a step 315 of generating a virtual badge that includes a visual representation that is based upon user profile data associated with the consumer and in some instances the action that prompted the generation of the virtual badge.

After the virtual badge has been generated, the method 300 may include a step 320 of providing the virtual badge in a form that is displayable via a graphical user interface.

Optionally, the method 300 may include a step 325 of selectively modifying the schema based upon actions performed by the consumer. For example, the schema may be modified to update the number of actions that must be executed by the consumer to obtain a virtual badge. Modification may include increasing or decreasing the number of actions based upon feedback obtained for the consumer.

FIG. 4 illustrates an exemplary computing system 400 that may be used to implement an embodiment of the present technology. One or more aspects of the computing system 400 may be implemented within any of e-commerce system 105, client device 110, and/or system 115. The computing system 400 of FIG. 4 includes one or more processors 410 and memory 420. Main a memory store 420 stores, in part, instructions and data for execution by processor 410. Main a memory store 420 can store the executable code when the system 400 is in operation. The system 400 of FIG. 4 may further include a mass storage device 430, portable storage medium drive(s) 440, output devices 450, user input devices 460, a graphics display 440, and other peripheral devices 480.

The components shown in FIG. 4 are depicted as being connected via a single bus 490. The components may be connected through one or more data transport means. Processor unit 410 and main a memory store 420 may be connected via a local microprocessor bus, and the mass storage device 430, peripheral device(s) 480, portable storage device 440, and display system 470 may be connected via one or more input/output (I/O) buses.

Mass storage device 430, which may be implemented with a magnetic disk drive or an optical disk drive, is a non-volatile storage device for storing data and instructions for use by processor unit 410. Mass storage device 430 can store the system software for implementing embodiments of the present technology for purposes of loading that software into main a memory store 410.

Portable storage device 440 operates in conjunction with a portable non-volatile storage medium, such as a floppy disk, compact disk or digital video disc, to input and output data and code to and from the computing system 400 of FIG. 4. The system software for implementing embodiments of the present technology may be stored on such a portable medium and input to the computing system 400 via the portable storage device 440.

Input devices 460 provide a portion of a user interface. Input devices 460 may include an alphanumeric keypad, such as a keyboard, for inputting alphanumeric and other information, or a pointing device, such as a mouse, a trackball, stylus, or cursor direction keys. Additionally, the system 400 as shown in FIG. 4 includes output devices 450. Suitable output devices include speakers, printers, network interfaces, and monitors.

Display system 470 may include a liquid crystal display (LCD) or other suitable display device. Display system 470 receives textual and graphical information, and processes the information for output to the display device.

Peripherals 480 may include any type of computer support device to add additional functionality to the computing system. Peripheral device(s) 480 may include a modem or a router.

The components contained in the computing system 400 of FIG. 4 are those typically found in computing systems that may be suitable for use with embodiments of the present technology and are intended to represent a broad category of such computer components that are well known in the art. Thus, the computing system 400 of FIG. 4 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Mac OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, SSDs (solid-state drives), and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), any other optical storage medium, RAM, PROM, EPROM, a FLASHEPROM, any other memory chip or cartridge.

While certain exemplary embodiments have been described and shown in the accompanying drawings, it is to be understood that such embodiments are merely illustrative and not restrictive of the broad disclosure and that this disclosure is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

In the foregoing specification, specific embodiments of the present disclosure have been described. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

What is claimed is:

1. A method for facilitating virtual badges within e-commerce systems associated with enterprises, the method comprising: providing a virtual badge that is displayable via a graphical user interface, the virtual badge being provided in response to at least one action executed by a consumer within an e-commerce system, the virtual badge comprising a visual representation that is based upon user profile data associated with the consumer.

2. The method according to claim 1, further comprising receiving a schema for providing virtual badges to a consumer, the schema being established by the enterprise, the schema comprising one or more actions that are to be executed by the consumer prior to receiving a virtual badge.

3. The method according to claim 2, further comprising providing a visual indicator upon the consumer receiving virtual badges that complete a collection.

4. The method according to claim 2, wherein the schema further defines a collection of virtual badges, the collection comprising a plurality of different virtual badges that are to be obtained to complete the collection.

5. The method according to claim 4, further comprising providing a reward to the consumer in response to the consumer completing at least a portion of the collection.

6. The method according to claim 5, wherein the reward includes at least one of a virtual reward and a physical reward redeemable by the customer, the reward being associated with products or services offered by the enterprise.

7. The method according to claim 1, further comprising providing an announcement, via the graphical user interface, upon the consumer executing an action that causes the provision of a virtual badge.

8. The method according to claim 1, further comprising selectively modifying the number of actions that are to be executed by the consumer to obtain a virtual badge.

9. The method according to claim 1, further comprising integrating the visual representation of the virtual badge within a website of the enterprise.

10. A system for facilitating virtual badges within e-commerce systems associated with enterprises, the system comprising:
a memory for storing executable instructions that facilitate virtual badges within e-commerce systems associated with enterprises;
a processor that executes the instructions;
a notification module that receives a request to generate a virtual badge, the virtual badge being generated in response to at least one action executed by a consumer within an e-commerce system;
a virtual badge generator that generates the virtual badge, the virtual badge comprising a visual representation that is based upon user profile data associated with the consumer; and
a user interface module that provides a virtual badge that is displayable via a graphical user interface.

11. The system according to claim 10, further comprising a planning module that receives a schema for providing virtual badges to a consumer, the schema comprising one or more actions that are to be executed by the consumer prior to receiving a virtual badge.

12. The system according to claim 11, wherein the planning module selectively modifies the schema based upon actions performed by the consumer.

13. The system according to claim 11, wherein the schema further defines a collection of virtual badges, the collection comprising a plurality of different virtual badges that are to be obtained to complete the collection.

14. The system according to claim 13, further comprising a reward module that provides a reward to the consumer in response to the consumer completing at least a portion of the collection.

15. The system according to claim 11, wherein the user interface module provides a visual indicator upon the consumer receiving one or more virtual badges that complete a collection.

16. The system according to claim 14, wherein the reward includes at least one of a virtual reward and a physical reward that may be redeemed by the customer, the reward being associated with products or services offered by the enterprise.

17. The system according to claim 10, wherein the user interface module further provides an animated announcement, via the graphical user interface, upon the consumer executing an action that causes the provision of a virtual badge.

18. The system according to claim 10, wherein the user interface module provides the visual representation of the virtual badge to the enterprise for integration within a website.

19. A non-transitory computer readable storage media having a program embodied thereon, the program being executable by a processor to perform a method for facilitating virtual badges within e-commerce systems associated with enterprises, the method comprising: providing a virtual badge that is displayable via a graphical user interface, the virtual badge being provided in response to at least one action executed by a consumer within an e-commerce system, the virtual badge comprising a visual representation that is based upon user profile data associated with the consumer.
